(19) United States
(12) Patent Application Publication
(10) Pub. No.: US 2024/0426443 A1
(43) Pub. Date: Dec. 26, 2024

(54) LIGHTING DEVICE FOR A VEHICLE

(71) Applicant: Hella GmbH & Co. KGaA, Lippstadt (DE)

(72) Inventor: Martin Vollmer, Anröchte (DE)

(21) Appl. No.: 18/751,510

(22) Filed: Jun. 24, 2024

(30) Foreign Application Priority Data
Jun. 26, 2023 (DE) 102023116695.6

(51) Int. Cl. F21S 41/176; F21S 41/143; F21S 41/148; F21S 41/24; F21S 41/40

(52) U.S. Cl. CPC F21S 41/176; F21S 41/143; F21S 41/148; F21S 41/24; F21S 41/40

(57) ABSTRACT

A lighting device for a vehicle contains a light module with at least one light-emitting diode and a light-emitting surface lit by the at least one light-emitting diode, from which light is emitted when the lighting device is in use. The light module has an optical component containing a converter, which is between the at least one light-emitting diode and the light-emitting surface, or forms the light-emitting surface. The lighting device is designed such that the light from the at least one light-emitting diode passes through the optical component and strikes the light-emitting surface. The converter alters the wavelength spectrum of the light passing through the optical component.

### CROSS REFERENCE

This application claims priority to German Application No. 10 2023 116695.6, filed Jun. 26, 2023, the entirety of which is hereby incorporated by reference.

### FIELD OF THE INVENTION

The present invention relates to a lighting device for a vehicle.

### BACKGROUND OF THE INVENTION

WO 2023/025626 A1 discloses such a lighting device. This lighting device contains a light module, which has numerous light-emitting diodes and a surface that is lit by the light-emitting diodes, from which light is emitted when the lighting device is in use, and an LCD, at least part of which is in front of the light-emitting surface such that when the lighting device is in use, at least part of the light emitted from this surface enters an entry surface of the LCD and exits an exit surface thereof, and the lighting device allows part of the light striking the entry surface to pass through the LCD, and prevents the other part from passing through the LCD. The lighting module contains a flat waveguide, at one end of which the light from the light-emitting diodes enters, and has an exit surface that is at a right angle thereto, from which the light is directed toward the light-emitting surface.

The disadvantage with this is that the contrast at the exit surface of the LCD between the areas that allow light to pass through and the areas where at least part of the light is not allowed to pass through is frequently regarded as inadequate. This is partly because the light-emitting surface is not lit sufficiently brightly and/or homogeneously.

Furthermore, the red light-emitting diodes used for generating tail lights or braking signals quickly degrade, further lowering the contrast.

### BRIEF SUMMARY OF THE INVENTION

The fundamental problem addressed by the invention is therefore to create a lighting device of the above type that results in higher contrast in the light-emitting surface of the light module, and/or the at least one light-emitting diode that generates the light with which the light-emitting surface is lit when the lighting device is in use, degrades less quickly.

In an example embodiment, the light module contains an optical component with a converter, which is between the at least one light-emitting diode and the light-emitting surface, or forms the light-emitting surface, and the lighting device is designed such that the light from the light-emitting diode passes through the optical component and strikes the light-emitting surface, during which the converter in the optical component converts the wavelength spectrum of the light passing through it. The converter can also contribute to homogenization of the light exiting the light module through diffusion thereof, such that there is no need for the diffusing optical panels normally used in light modules. Furthermore, the converter eliminates the need for red light-emitting diodes, such that the at least one light-emitting diode generating the light that illuminates the light-emitting surface degrades less quickly.

The lighting device can contain an LCD, at least part of which is in front of the light-emitting surface, such that when the lighting device is in use, at least part of the light exiting the light-emitting surface enters an entry surface of the LCD and exits an exit surface thereof, and the lighting device controls the LCD such that part of the light striking the entry surface is allowed to pass through the LCD, and the other part is not. A higher contrast can be obtained at the exit surface of the LCD through this design of the light module according to the invention.

The at least one light-emitting diode can be designed to emit blue or white light, and the converter can be designed to alter the color of the light from the at least one light-emitting diode, e.g. converting blue or white light to red, or blue light to white.

The optical component containing the converter can be an optical panel or film. Both panels and films can be thin, such that the lighting device can still be compact, despite the optical component containing the converter.

At least one surface of the optical component containing the converter through which the light from the light-emitting diodes passes can be curved. This results in an optical component that can assume other functions in addition to converting the color of the light.

At least one surface of the optical component containing the converter through which the light from the light-emitting diode passes can be structured. This structure can contribute to homogenization of the light exiting the light module.

The converter can be a coating containing converter material on at least one surface of the optical component, through which the light from the light-emitting diodes passes. The converter can also comprise converter material integrated in the optical component, in particular when the optical component obtained through injection molding, and the starting material for this contains the converter material. In both cases, the converter material can contribute to the homogenization of the light exiting the light module through diffusion.

The optical component containing the converter can be spaced apart from the at least one light-emitting diode. This ensures that as much of the surface of the optical component containing the converter as possible is lit by the light-emitting diode.

The at least one light-emitting diode can be placed in the light module such that when the lighting device is in use, the light generated by the at least one light-emitting diode is substantially emitted directly toward the light-emitting surface. This direct illumination results in the light from the at least one light-emitting diode more effectively reaching the light-emitting surface, such that the contrast at the exit surface of the LCD can be heightened. Furthermore, when numerous light-emitting diodes are used, individual light-emitting diodes can be dimmed, for example, such that different parts of the entry surface on the LCD are lit at different levels, further heightening the contrast at the exit surface.

The light module can contain at least one reflector dedicated to the at least one light-emitting diode such that when the lighting device is in use, part of the light from the at least one light-emitting diode is reflected toward the light-emitting surface, wherein the light module preferably contains numerous reflectors, each of which is dedicated to a light-emitting diode, such that when the lighting device is in use, part of the light from the light-emitting diodes is reflected toward the light-emitting surface. With at least one reflector, the light from the at least one light-emitting diode reaches the light-emitting surface more effectively.

The light module can contain a flat waveguide, one end of which forms an entry surface, and having at least one exit surface, and the lighting device is designed such that at least part of the light from the at least one light-emitting diode enters the entry surface of the waveguide, and at least partially exits the at least one exit surface toward the light-emitting surface. The wave guide can be structured, and the light moving through the waveguide can be at least partially deflected by the structure such that it exits the waveguide through the exit surface. This design also results in a comparatively homogenous lighting of the light-emitting surface, or the entry surface of the LCD.

The light module can contain a structured optical panel between the optical component containing the converter and the light-emitting surface, or forming the light-emitting surface. This additional optical panel can further increase the homogeneity with which the light-emitting surface or the LCD is lit.

The lighting device can have a housing on or in which the light module is placed, in particular with the LCD placed on the light module or the housing.

The LCD can be a guest host display or smart glass display. These displays require no polarization filter, resulting in a higher level of available light transmission, which is advantageous and decisive in obtaining a lighting function with a small lighting element. Further, by eliminating the polarization, the direction from which it is viewed becomes irrelevant.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a schematic sectional view of a first embodiment of the lighting device according to the invention.

FIG. 2 shows a schematic sectional view of a second embodiment of the lighting device according to the invention.

### DETAILED DESCRIPTION OF THE DRAWINGS

Identical and functionally identical parts have the same reference symbols in the drawings.

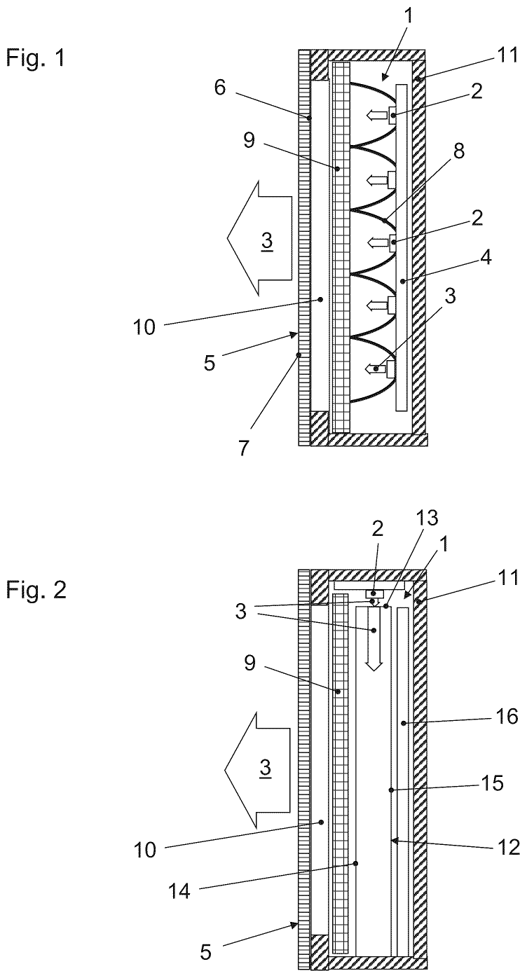

The first embodiment of the lighting device shown in FIG. 1 contains a light module 1 with numerous light-emitting diodes 2 with which blue or white light 3 is generated. The light-emitting diodes 2 populate a single printed circuit board 4.

The light module 1 contains a light-emitting surface, which can be formed by an outer panel, not shown, or another part of the light module 1 that shall be described in greater detail below. There is an LCD 5 adjoining the light emitting surface, which has an entry surface 6 facing the light-emitting surface, and an exit surface 7 on the opposite side.

Alternatively, the LCD can be omitted.

The light-emitting diodes 2 are placed in the light module 1 such that when the lighting device is in use, the light 3 from the light-emitting diodes is emitted substantially toward the light-emitting surface, or the entry surface 6 on the LCD 5. The light module 1 also contains numerous reflectors 8, each of which encompasses a light-emitting diode 2, such that when the lighting device is in use, part of the light 3 from the light-emitting diodes 2 is reflected toward the light-emitting surface.

The light module 1 also has an optical component 9 containing a converter, which is between the light-emitting diodes 2 or the reflectors 8, and the light-emitting surface. The optical component 9 can also form the light-emitting surface.

The light 3 from the light-emitting diodes 2 can pass through the optical component 9 and enter the LCD 5 at the entry surface 6 thereof, and the converter can alter the wavelength spectrum of the light 3 passing through the optical component 9. The converter alters the color of the light 3 from the light-emitting diodes in particular, e.g. converting blue or white light to red, or blue light to white.

The optical component 9 containing the converter can be an optical panel or optical film. It has an entry surface facing the light-emitting diodes 2 or the reflectors 8, and an exit surface on the opposite side, for the light 3 from the light-emitting diodes 2.

At least one of these surfaces through which the light 3 from the light-emitting diodes passes can be curved. Consequently, the optical component 9 containing the converter can also function as a lens. At least one of these surfaces can also be structured. The structure can contribute to the homogenization of the light 3 from the light module 1.

The converter can form a coating containing a converter material on at least one of the surfaces of the optical component 9 forming either the entry or exit surface. The converter can also be converter material integrated in the optical component 9. The optical component can be injection molded, using a starting material containing the converter material. In both cases, the converter material can contribute to the homogenization of the light 3 exiting the light module 1 through diffusion.

The light module 1 also contains a structured optical panel 10 between the optical component 9 containing the converter and the light-emitting surface formed by an outer panel, for example, not shown in the figures. The structured optical panel 10 can also form the light-emitting surface. This additional optical panel 10 can further increase the homogeneity of the light with which the light-emitting surface or the entry surface 6 of the LCD 5 is lit.

The lighting device also has a housing 11 in which the light module 1 is contained. In the exemplary embodiment shown in FIG. 1, the LCD 5 is on the exit side of the light 3 generated by the light module 1 on the housing 11, such that the entry surface of the LCD borders on the light-emitting surface of the light module 1, and the light-emitting surface is formed by an outer panel, not shown, the structured optical component 10, or the optical component 9 containing the converter.

The LCD 5 is a guest host display or smart glass display in particular. The LCD 5 can allow part of the light 3 striking the entry surface 6 to pass through the LCD 5, and prevent part of the light 3 striking the entry surface 6 from passing through the LCD 5.

The second embodiment shown in FIG. 2 differs from the first, shown in FIG. 1, in that the light-emitting diodes 2 are placed in the light module 1 such that when the lighting device is in use, the light 3 generated by the light-emitting diodes 2 exits substantially parallel to the light-emitting surface, or the entry surface 6 of the LCD 5. This direction is downward in FIG. 2. There are numerous light-emitting diodes 2, which are adjacent to one another in a direction perpendicular to the drawing plane of FIG. 2.

The second embodiment of the lighting device contains a waveguide 12 with an entry surface at one end 13, where the light 3 from the light-emitting diodes 2 enters, and moves downward in FIG. 2. The waveguide 12 has an exit surface 14 facing the light-emitting surface or the entry surface 6 of the LCD 5, through which the light 3 exits toward the light-emitting surface or the entry surface 6 of the LCD 5.

The waveguide 12 can be structured on the side opposite the exit surface 14, such that the light 3 moving through the waveguide 12 can be at least partially deflected toward the exit surface 14 of the waveguide 12.

The light module 1 shown in FIG. 2 can also contain a reflector 16 outside the waveguide 12 on the side facing away from the LCD 5. In this case, the light module 1 is configured such that the light 3 exits the surface 15 opposite the exit surface 14 toward the right in FIG. 2, is reflected back toward the waveguide 12 by the reflector 15, reenters the waveguide through the surface 15 opposite the exit surface 14 toward the left in FIG. 2, and exits the waveguide 12 toward the optical component 9 containing the converter.

### LIST OF REFERENCE SYMBOLS

1 light module
2 light-emitting diode
3 light generated by the light-emitting diodes
4 printed circuit board
5 LCD
6 LCD entry surface
7 LCD exit surface
8 reflector
9 optical component containing a converter
10 structured optical panel
11 housing
12 waveguide
13 waveguide entry surface
14 waveguide exit surface
15 waveguide surface opposite the exit surface
16 reflector

1. A lighting device for a vehicle, the lighting device comprising:
a light module with at least one light-emitting diode, and with a light-emitting surface lit by the at least one light-emitting diode, from which light is emitted when the lighting device is in use,
wherein the light module has an optical component containing a converter, which is between the at least one light-emitting diode and the light-emitting surface, or forms the light-emitting surface,
wherein the light from the at least one light-emitting diode passes through the optical component and strikes the light-emitting surface,
wherein the converter alters the wavelength spectrum of the light passing through the optical component.

2. The lighting device according to claim 1, further including an LCD, at least part of which is in front of the light-emitting surface such that when the lighting device is in use, at least part of the light from the light-emitting surface enters an entry surface on the LCD and exits an exit surface on the LCD,
LCD is controlled such that part of the light striking the entry surface is allowed to pass through the LCD and another part of the light striking the entry surface is prevented from passing through the LCD.

3. The lighting device according to claim 1, wherein the at least one light-emitting diode emits blue or white light, and the converter alters a color of the light from the at least one light-emitting diode.

4. The lighting device according to claim 1, wherein the optical component containing the converter is an optical panel or optical film.

5. The lighting device according to claim 1, wherein at least one surface of the optical component containing the converter, through which the light from the light-emitting diodes passes, is curved.

6. The lighting device according to claim 1, wherein at least one surface of the optical component containing the converter, through which the light from the light-emitting diodes passes, is structured.

7. The lighting device according to claim 1, wherein the converter is formed by a coating containing a converter material on at least one surface of the optical component, through which the light from the light-emitting diodes passes, and/or the converter is formed by a converter material integrated in the optical component using a starting material containing the converter material.

8. The lighting device according to claim 1, wherein the optical component containing the converter is spaced apart from the at least one light-emitting diode.

9. The lighting device according to claim 1, wherein the at least one light-emitting diode is placed in the light module such that when the lighting device is in use, the light generated by the at least one light emitting diode exits substantially directly toward the light-emitting surface.

10. The lighting device according to claim 9, wherein the light module contains at least one reflector, which is dedicated to the at least one light-emitting diode such that when the lighting device is in use, part of the light from the at least one light-emitting diode is reflected toward the light-emitting surface such that when the lighting device is in use, part of the light from the light emitting diodes is reflected toward the light-emitting surface.

11. The lighting device according to claim 1, wherein the light module contains a flat waveguide with an entry surface at one end, and at least one exit surface, wherein the lighting device is designed such that at least part of the light from the at least one light-emitting diode enters the waveguide through the entry surface and at least part of this light exits the at least one exit surface toward the light-emitting surface.

12. The lighting device according to claim 11, wherein the waveguide is structured, wherein the lighting device is designed such that the light moving through the waveguide is at least partially deflected by the structure such that it exits the waveguide through the exit surface.

13. The lighting device according to claim 1, wherein the light module has a structured optical panel between the optical component containing the converter, and the light-emitting surface, or forms the light-emitting surface.

14. The lighting device according to claim 1, wherein the lighting device has a housing on or in which the light module is located.

15. The lighting device according to claim 1, wherein the LCD is a guest host display or a smart glass display.

16. The lighting device according to claim 7, wherein the optical component is injection molded.

17. The lighting device according to claim 10, wherein the light module contains numerous reflectors, each of which is dedicated to one of the light-emitting diodes.

18. The lighting device according to claim 14, wherein the LCD is on the light module or the housing.
